(19) United States
(12) Patent Application Publication
(10) Pub. No.: US 2020/0280280 A1
(43) Pub. Date: Sep. 3, 2020

(54) Power Generating Apparatus

(71) Applicant: Sunstone IP Systems LTD, Herne Bay (GB)

(72) Inventors: Paul Schelhaas, Herne Bay (GB); Simon Legrand, Herne Bay (GB)

(73) Assignee: Sunstone IP Systems LTD, Herne Bay (GB)

(21) Appl. No.: 16/649,897

(22) PCT Filed: Sep. 24, 2018
(86) PCT No.: PCT/GB2018/052713

§ 371 Date: Mar. 23, 2020

(30) Foreign Application Priority Data
Sep. 22, 2017 (GB) 1715315.6

(51) Int. Cl. H02S 10/40; H02S 10/12; H02S 20/30; H02S 40/38; H02S 40/42

(52) U.S. Cl. CPC H02S 10/40; H02S 10/12; H02S 40/425; H02S 40/38; H02S 20/30

(57) ABSTRACT

A power generating apparatus for use in remote locations, the apparatus including a shipping container; an elongate device support element secured to the shipping container and configured to be upstanding in use; an electrical energy storage assembly located within the shipping container, the electrical energy storage assembly having an electrical input and an electrical output, and comprising one or more rechargeable batteries; an electrical energy generator carried externally by the shipping container, wherein the electrical energy generator is the sole source of electrical energy and is powered by solar energy and optionally wind energy, the electrical energy generator including one or more photovoltaic panels configured to convert solar energy into electrical energy, the electrical energy from the electrical energy generator being electrically connected to the input of the energy storage assembly; and a powered device carried by the device support element, the powered device being selected from a camera, a lighting apparatus, a wireless communications assembly, a radar apparatus, a gas detection apparatus and combinations thereof, wherein the powered device is electrically coupled to the output of the energy storage assembly.

The present invention relates to a power generating apparatus, and in particular to a power generating apparatus which is capable of powering a camera, a wireless communications apparatus, a radar apparatus, a gas detection apparatus and/or a lighting apparatus in harsh and/or remote areas.

It is desired to provide a power generating apparatus which can be located at a remote and potentially inhospitable site and which can provide a remote powered device such as a camera, a lighting apparatus, a wireless communications assembly, a radar apparatus, a gas detection apparatus or combinations thereof. Such devices may be useful for monitoring functions, environmental conditions or activity at the remote site via the remote powered device. The inhospitable site may experience extremes of temperature and other damaging natural phenomena, such as acidic rain, dust, sand, etc.

Portable power generating apparatus which include photovoltaic panels as an adjunct to an internal combustion engine as a primary or secondary power source are known from US2013/0250561 and WO2014/056086. Portable power generating apparatus are also known from US2012/0201016 and US2006/0017809. However, these apparatus are based upon a mobile platform, i.e. a wheeled platform. In remote regions, such platforms are liable to theft.

WO2016/185034 discloses a portable power generating apparatus which requires an insulated housing.

According to a first aspect of the invention, there is provided a power generating apparatus for use in remote locations, the apparatus including a shipping container; an elongate device support element secured to the shipping container and configured to be upstanding in use; an electrical energy storage assembly located within the shipping container, the electrical energy storage assembly having an electrical input and an electrical output, and comprising one or more rechargeable batteries; an electrical energy generator carried externally by the shipping container, wherein the electrical energy generator is the sole source of electrical energy and is powered by solar energy and optionally wind energy, the electrical energy generator including one or more photovoltaic panels configured to convert solar energy into electrical energy, the electrical energy from the electrical energy generator being electrically connected to the input of the energy storage assembly; and a powered device carried by the device support element, the powered device being selected from a camera, a lighting apparatus, a wireless communications assembly, a radar apparatus, a gas detection apparatus and combinations thereof, wherein the powered device is electrically coupled to the output of the energy storage assembly.

By the term “shipping container” it is meant an intermodal shipping container which is formed from a steel frame, a steel floor, a number of container panels, and an opening which may be closed by pair of hinged doors. The container panels include a pair of opposed corrugated steel sides, a corrugated steel roof and a closed corrugated steel end located opposite to the opening.

Such containers tend to have a standardised width of 8 feet (2.4 m). The length of the container is typically 20 feet (6.1 m) or 40 feet (12.2 m) and the height is typically 8 ft 6 inches (2.6 m) or 9 ft 6 inches (2.9 m). Accordingly, the containers are typically available as a 20 ft standard container (20 ft long, 8 ft wide, 8 ft 6 high), a 20 ft high cube container (20 ft long, 8 ft wide, 9 ft 6 high), a 40 ft standard container (40 ft long, 8 ft wide, 8 ft 6 high) and a 40 ft high cube container (40 ft long, 8 ft wide, 9 ft 6 high). Such containers are well known and it is estimated that there are over 20 million such containers in the world at present. They are referred to as “intermodal” containers as they can be transported via sea, rail, or any combination thereof without unloading and reloading the container. The skilled person will readily understand what is meant by the term “shipping container” and “intermodal shipping container”.

Shipping containers are relatively easy to transport as lorry trailers and rail carriages exist which are specifically configured to carry the containers. In addition, many different types of handling equipment, such as cranes, forklift trucks, reach stackers, etc. exist for transferring the containers to and from the relevant transport vehicle.

It is known to re-purpose such shipping containers, for example for on-site storage or portable buildings, such a medical clinics or command centres. It is even known to convert existing shipping containers into homes, shops, cafes, etc.

It will be appreciated that the subject invention comprises a re-purposed shipping container which forms a part of the remote power generating apparatus. The container defines a substrate to which is secured one or more photovoltaic panels. Furthermore, it supports the elongate device support element and defines a housing within which the electrical energy storage assembly is located. As the container may be locked in a closed configuration, it may also provide additional secure storage for equipment at the remote location.

In the first aspect of the invention, the electrical energy storage assembly comprises one or more rechargeable batteries. The rechargeable batteries are protected from the environment by the shipping container, which provides a waterproof and windproof housing. The batteries are charged by the electrical energy generator carried externally by the shipping container and the batteries power the electrically powered device(s). The electrical energy generator suitably generates more electrical energy in a given period than is consumed by the electrically powered device(s). In this way, the apparatus can be located at a remote site and the remote site can be monitored in embodiments in which the electrically powered device includes a camera, a radar apparatus and/or a gas detection apparatus; and/or illuminated in embodiments in which the electrically powered device includes a lighting apparatus; and/or provide a wireless communications network in embodiments in which the electrically powered device includes a wireless communications assembly.

In the context of the present invention, a photovoltaic panel is a panel which carries a plurality of photovoltaic cells upon a surface thereof. The panels may be substantially planar or curved and they may be rigid or have a degree of flexibility. The photovoltaic cells may be protected via a polymeric or glass layer. The photovoltaic cells convert solar energy to electrical energy. The photovoltaic cells convert sunlight striking the cells into electrical energy.

The term “wireless communications assembly” is an apparatus which is capable of receiving and transmitting wireless signals, such as video, data and voice communications. It will be appreciated that such an assembly can function as a booster for an existing wireless network or it can provide a wireless communications network at a remote site. Where present in combination with a further electrically powered device, the wireless communications assembly may transmit to a remote receiving station data from the further electrically powered device, such as images from a camera or data from a radar apparatus or gas detection apparatus.

The term “camera” includes video cameras, in particular, video cameras that can pan, tilt and/or zoom (e.g. PTZ cameras).

The radar apparatus of the subject invention may be used to monitor the movement of vehicles about a site or relative to a site. For example, the radar apparatus may be used to monitor the movement of aircraft around a remote, temporary airfield or it may be used to monitor the movement of vehicles along a road running adjacent to the apparatus.

The gas detection apparatus may be used to measure air quality at the remote site or to detect specific gases in the environment surrounding the apparatus.

The electrical energy generator may comprises two or more photovoltaic panels. In such embodiments, the electrical energy generator may comprises at least one fixed photovoltaic panel and/or at least one movable photovoltaic panel which has a variable orientation. The fixed panel, where present, suitably has a substantially vertical or horizontal orientation, e.g. within about 10° of a vertical or horizontal plane. According to an embodiment of the invention, the electrical energy generator may comprise one or more photovoltaic panels which is/are adapted to have a variable orientation. The apparatus suitably includes two or more photovoltaic panels.

The term “variable orientation” means that at least one of the panels may be mounted for movement, such as rotation, relative to a fixed plane, such as the plane of a panel to which the panel(s) is/are secured. In this way, the panels may be moved periodically for optimum solar performance.

In an alternative embodiment, the electrical energy generator may comprise two or more photovoltaic panels wherein all of the panels have a variable orientation relative to the container panel of the shipping container to which they are secured. In the context of the present invention, the term “container panel” includes side walls of the container, end walls of the container and the roof of the container. For example, the photovoltaic panels may be hingedly coupled to a respective container panel of the container or they may be pivotally coupled to the respective container panel.

The or each photovoltaic panel may be located on the roof of the container, on at least one of the side walls of the container and/or on the end wall of the container. In the context of the present invention, the shipping container comprises one fixed end wall opposite to the pair of doors that form the opening into the interior of the container. Accordingly, reference to the end wall of the container is intended to mean the fixed end wall opposite to the opening. Where more than one photovoltaic panel is provided, the panels may be located on the same panel of the container or on different panels of the container.

In embodiments of the invention in which one or more of the photovoltaic panels is/are mounted for variable orientation, the or each photovoltaic panel may include an adjustment arm which may be used to fix the photovoltaic panel in a desired orientation relative to the container panel to which it is secured. Alternatively a motor adapted to move the photovoltaic panel from a first orientation to a second orientation in embodiments in which the panels may be provided, wherein the motor moves the respective photovoltaic panel(s) remotely (e.g. in response to a remote command signal) or at pre-determined periods in time. In this embodiment, the motor may be controlled such that the orientation of the or each photovoltaic panel tracks the position of the sun in the sky to provide a desired amount of solar irradiation. Alternatively, the motor may be controlled to move the respective panel periodically. The motor may include a controller which may be adapted to receive a control signal such that the orientation of the respective panel may be controlled remotely.

The fixed photovoltaic panels, where present, may be located in a substantially vertical orientation. In such an orientation, they may prevent or resist an accumulation of snow or other solid contaminant (such as sand or dust) on the panel. Thus, even though a vertical or near vertical orientation may not provide an optimum solar performance, such photovoltaic panels are nevertheless still able to generate electrical energy when other panels may be compromised by foreign matter, such as snow, sand, dirt or dust. To compensate for the reduced solar performance, the or each vertically oriented photovoltaic panel may be accompanied by one or more horizontally oriented photovoltaic panels, i.e. secured to the roof of the shipping container, and/or one or more photovoltaic panels having a variable orientation relative to the container panel to which they are secured.

Suitably, in embodiments in which at least one of the photovoltaic panels is configured to have a variable orientation, the or each photovoltaic panel may have an operational orientation in which it is arranged for optimum solar strike (i.e. is arranged to receive a desired level of solar energy) and it may have a transport orientation in which the or each panel is arranged to lie parallel and adjacent to a respective container panel (e.g. a wall, end or the roof) of the shipping container.

In order to protect the photovoltaic cells carried by the photovoltaic panels, the or each photovoltaic panel may be coated with protective barrier layer formed from a glass material or a polymeric material. Suitably, the protective barrier layer does not reduce or impair the intensity of the light which strikes the photovoltaic cells. Thus, it does not reduce the efficiency or electrical output of the photovoltaic panel. The protective barrier layer is suitably a hydrophobic material.

It will be appreciated that a build-up of dust, dirt, sand or any other contaminants on the panels will reduce the electrical output of the panel. Therefore, the or each panel may include a cleaning apparatus, such as a fluid cleaning apparatus. The fluid cleaning apparatus suitably includes a fluid reservoir, a pump and at least one nozzle to direct a flow of the cleaning fluid across the panel. The cleaning fluid may be compressed air (in which case, the fluid reservoir may be the atmosphere around the housing); an aqueous liquid; or an organic liquid. The fluid is suitably an aqueous liquid. The aqueous liquid may include additives, such as a detergent or an agent to lower the freezing point of the liquid (an anti-freeze).

At least one of the photovoltaic panels may be flexible. This allows for solar performance across a wide range of solar positions.

To provide a cooling effect for the interior of the shipping container, a container panel (e.g. a wall panel and/or a roof panel) may include one or more vents in communication with the environment external to the housing. The vent may closable and may define an open configuration in which the interior of the container is in fluid communication with an external environment, and a closed configuration in which the interior of the container is isolated from the external environment. Thus, the vent may be opened to vent heat out of the container and prevent the energy storage assembly and other components from overheating when the external temperature is relatively high, and, if the external temperature is relatively low (e.g. during winter), the vent may be closed so that interior of the container is isolated from the external environment in order to prevent heat loss from the interior of the housing.

In an embodiment of the invention, the electrical energy storage assembly is located within a compartment defined within the interior of the container. In embodiments in which the energy storage assembly is located within a compartment defined within the container, the compartment may include one or more heating elements, which in turn may be electrically connected to the electrical output from the energy storage assembly. In this way, the compartment may be heated when the external temperature drops below a pre-determined threshold. In such embodiments, the rechargeable batteries of the energy storage assembly are maintained at or above a minimum efficient operating temperature. It is well known that rechargeable batteries experience a significant decrease in efficiency as their temperature decreases and a heated compartment prevents or minimises the risk that the energy storage assembly will provide less electrical energy than is required to operate the electrically powered device(s).

In embodiments in which the at least the electrical energy storage assembly is located within a compartment defined within the interior of the container, the compartment may be insulated. For example, the compartment may comprise one or more walls, wherein the or each wall includes an insulating material or each wall is double-skinned and defines between the skins an air gap. Optionally, the walls are double skinned and include an insulating material in the gap defined between the skins.

As noted above, the compartment may further include a heater. Additionally or alternatively, the compartment may include a cooling apparatus, such as a fan, and one or more vents to vent the heat from the compartment.

In an embodiment of the invention, the or each rechargeable battery is enclosed within a polymeric barrier layer. The polymeric barrier layer is suitably a relatively poor thermal conductor and functions to provide an additional layer of protection for the battery or batteries which comprise the energy storage assembly. For use in cold climates, the or each rechargeable battery may be enclosed within a polymeric barrier layer and a heating element may be provided within the polymeric barrier layer. In the context of the present invention, the term “within” means that the heating element may be located between the battery and the outer barrier layer or it may be embedded within the polymeric barrier layer. The heating element may be electrically connected to an electrical output from the or each battery. Thus, the or each battery may be self-heating.

In an embodiment of the invention, the temperature of the energy storage assembly is maintained above a threshold temperature. This may be achieved by locating the or each rechargeable battery in a compartment defined within the container which is heated or by using self-heating batteries.

Rechargeable batteries may produce gaseous by-products during operation and such gaseous products may be explosive, flammable and/or toxic. In order to reduce the risk of fire or an explosion within the housing, or the build-up of toxic gases, the energy storage assembly may include one or more exhaust conduits in fluid communication with an environment external to the container, whereby any gases generated by the energy storage assembly in use are vented outside of the container.

The elongate device support element may be secured to the roof of the shipping container or it may be secured to the floor of the container and extend through an opening formed through the roof of the container. By securing the elongate device support element to the floor of the shipping container, the apparatus has a reduced overall height. However, an opening has to be defined in the roof in such embodiments, which may negatively impact the weathertightness of the container. Securing the elongate device support element to the roof of the shipping container allows the shipping container to retain its waterproof and windproof properties, but it increases the overall height of the apparatus.

For ease of construction, the elongate device support element is suitably secured to a roof panel of the container.

As the elongate device support element is often several metres high and the electrical device is typically carried at or towards the top of the support element, the elongate device support element may comprise a mast-like body and a base, wherein the base is secured to the shipping container and the mast-like body supports the or each electrically powered device. The mast-like body is usefully adapted to pivot relative to the base. Additionally or alternatively, the mast-like body may be configured to telescope relative to the base. In this way, if it is necessary to access the or each electrically powered device in situ, the mast-like body may be pivoted and/or telescopically retracted or lowered relative to the base such that access to the electrically powered device is permitted or made easier.

The mast-like body suitably has an erect configuration in which the or each electrically powered device is located away from the base, and a retracted configuration in which the or each electrically powered device is located towards the base. Thus, in embodiments in which the mast-like body is capable of pivoting relative to the base, the mast-like body is substantially upright in its erect configuration (i.e. substantially vertical when the shipping container is located on a substantially horizontal substrate). In embodiments in which the mast-like body is a telescopic body, the body is extended in its erect configuration.

The elongate device support element may include a latch arrangement such that the mast-like body may be latched in its erect configuration and/or it may latched in its retracted configuration.

The device support element is suitably formed from a metal, such as steel or aluminium. To minimise the impact of environmental pollutants or contaminants, such as sand, dust, acid rain and such like, the device support element is suitably coated or treated with a protective layer. For example, the metal may be galvanised, powder coated or coated with a polymeric layer.

A base portion of the shipping container may define channels which in use are substantially horizontal. Such channels suitably function as fork-lift access points, whereby the channels are arranged to receive therein respective forks of a fork-lift truck. Additionally or alternatively, the shipping container typically includes one or more lifting couplings which are adapted to be coupled to respective cables, chains or ropes of a lifting apparatus, such as a crane. The lifting couplings are typically formed at the four corners of the roof panel of the container. Accordingly, the power generating apparatus of the invention may be portable, but not by itself mobile. In the context of the present invention, portable is intended to be understood as the apparatus may be moved from one place to another by placing it on the bed of a lorry or other suitable transporter, whereas mobile is intended to mean that the base is wheeled such that it can be towed from place to place. Thus, the shipping container of the invention is not capable of translational movement along to the ground; it has to be raised above the ground before it can be moved via a secondary vehicle or apparatus.

As noted above, shipping containers typically comprise a pair of doors which substantially define an end wall of the container. Thus, in an embodiment of the invention, the interior of the shipping container may be accessed via a pair of doors which are located at one end of the container. Suitably, the pair of doors substantially define one end wall of the container such that the end of the container is open when the doors are in an open configuration and the end of the container is closed when the doors are in a closed configuration.

The container may further include a door formed in one of the side panels of the container.

According to an embodiment of the invention, the apparatus further includes a GPS location device electrically connected to an output from the energy storage assembly. Such an arrangement allows a remote monitoring station to ensure its correct location and also to help locate the apparatus in the event of theft or unauthorised movement of the apparatus.

According to a further embodiment of the invention, the apparatus further includes a wireless communications receiver/transmitter. The wireless communications receiver/transmitter is suitably electrically connected to an output from the energy storage assembly. The wireless communications receiver/transmitter allows images captured by a camera (where the electrically powered device comprises a camera), data from the radar apparatus and/or data from a gas detector to be transmitted to a remote monitoring station. It also allows for electronic remote control signals to be sent to the apparatus and for performance and status information concerning the apparatus to be sent to the remote monitoring station.

The skilled person will appreciate that the features described and defined in connection with the aspect of the invention and the embodiments thereof may be combined in any combination, regardless of whether the specific combination is expressly mentioned herein. Thus, all such combinations are considered to be made available to the skilled person.

An embodiment of the invention will now be described, by way of example only, with reference to the accompanying drawings in which:

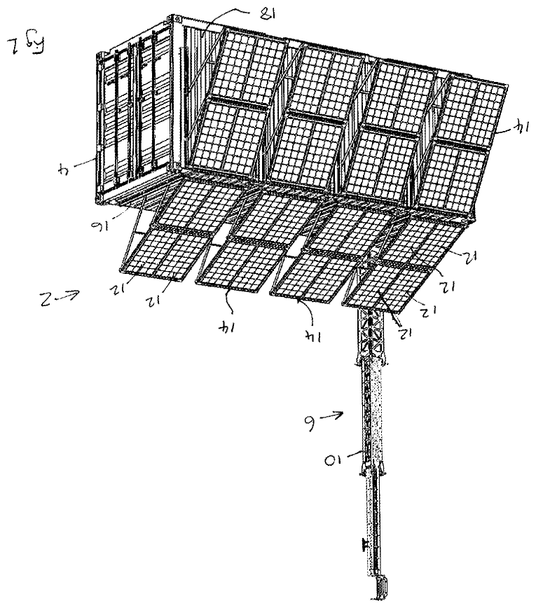

FIG. 1 is a perspective view of an apparatus according to the invention which shows a first side wall of the container; and

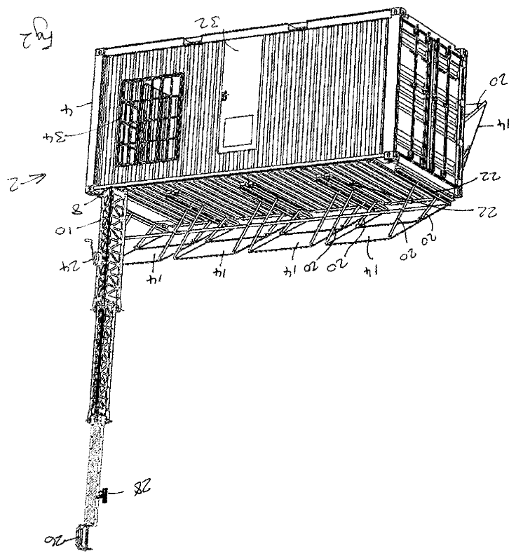

FIG. 2 is a perspective view of the apparatus shown in FIG. 1 which shows a second, opposite side wall of the container.

For the avoidance of doubt, the skilled person will appreciate that in this specification, the terms “up”, “down”, “front”, “rear”, “upper”, “lower”, “width”, etc. refer to the orientation of the components as found in the example when installed for normal use as shown in the Figures.

FIGS. 1 and 2 show a power generating apparatus 2 comprising a shipping container 4 and an elongate device support element 6 including a base 8 and a mast 10. The mast 10 is formed from a latticework of metal struts, which are galvanised for corrosion resistance.

The shipping container 4 carries thirty two photovoltaic panels 12 which together are capable of generating over 1000 W of power. The panels 12 are arranged as eight photovoltaic arrays 14, wherein each array includes four photovoltaic panels 12.

Each of the photovoltaic arrays 14 are hingedly coupled at one end thereof to a respective panel of the shipping container 4. A roof panel 16 of the container 4 carries four of the hinged arrays 14 and a first side wall 18 of the container carries the other four of the hinged arrays 14.

Each of the arrays 14 includes four support arms 20. A proximal end of each support arm 20 is hingedly coupled to a side of the respective array 14. A distal end of each support arm 20 is located within a linear track 22 which is secured to the relevant panel of the container 4. The distal end of the support arms 20 includes a restraining element (not shown) which defines a free configuration in which the distal end of the support arms 20 is allowed to move along the respective track 22, and a locked configuration in which the distal end of the support arms 20 is prevented from movement relative to the track. Such restraining elements are well known and need not be described in detail herein.

The skilled person will appreciate that the arrangement of the hinged array 14, the support arms 20 and the linear track 22 allows each array to be oriented in a pre-determined orientation relative to the container panel to which they are secured. In the embodiment shown in the Figures, the arrays 14 may be oriented relative to the relevant panel by between 0° (in which the array 14 is arranged to be parallel and adjacent to the panel) and about 45°. However, the skilled person will appreciate that by altering the support arms 20, it would be possible to provide a range of orientation between 0° and about 90°.

Each array 14 may be oriented differently with respect to the neighbouring or adjacent arrays 14.

The base 8 of the elongate device support element 6 is riveted or welded to the roof panel 16 and the mast 10 extends upwardly therefrom. The mast 10 is welded to the base 8. The mast 10 is telescopic and is raised and lowered by a winch apparatus 24 connected to an operating cable (not shown). Again, such winch systems are well known in the context of telescopic masts. The winch apparatus 24 may include a clutch that locks the mast 10 at the desired height or the mast 10 may include a latch which is configured to latch the mast in its fully extended configuration.

In an alternative embodiment (not shown), the mast 10 is hingedly coupled to the base 8 such that the mast may be arranged substantially parallel to the roof panel 16 in a transportation configuration, and may be arranged substantially perpendicular to the roof panel 16 in an operational configuration.

At the top of the mast 10 is located a CCTV video camera 26 which can pan, tilt and zoom (a PTZ camera). Although this particular embodiment carries a video camera 26 as the electrical device, it could instead be any other type of electrically operated device, such as a lighting apparatus, such as an LED lighting apparatus; a radar transceiver; and/or a gas analyser. The camera 26 (and/or further electrically operated device) is electrically connected to an output of an electrical energy storage assembly (not shown) located within the container 4 and discussed below.

The mast 10 also carries a wireless access point 28 which is capable of receiving and transmitting data at up to 125 Mbps. The wireless access point 28 is also electrically connected to an output of the electrical energy storage assembly. Such wireless access points are well known in the art and as such, it will not be described in detail herein. The data from the video camera 26 is transmitted to a remote monitoring station via the wireless access point 28.

A second side wall 30 of the container 4 defines therein a door 32 which provides access to the interior of the container 4, and a window 34 which provides natural light to the interior of the container 4.

Within the container 4 is provided a compartment in the form of a cabinet (not shown) which is fixed to the floor of the container.

The cabinet includes a welded stainless steel frame and powder coated aluminium panels. The cabinet further includes a door which carries around its internal periphery a polyurethane gasket to provide a further level of protection against the ingress of dust and water. The panels of the cabinet are double skinned and comprises an inner skin, an outer skin and an air gap between them within which is located an insulating material. At least one of the panels includes a vent such that the air within the cabinet is in fluid communication with the air within the container 4. This is important to prevent the potentially explosive build-up of hydrogen gas (or other gases generated by the batteries in use) in the cabinet. The container 4 may also include one or more vents to disperse further any hydrogen gas generated as a result of the charging and discharging of the batteries (discussed below). The vents of the container 4 permit the environment within the container 4 to be in fluid communication with the environment external to the container 4.

The interior of the cabinet is sized to receive therein a plurality of rechargeable batteries (not shown) and a controller (not shown) to control the flow of electrical energy to and from the batteries. Accordingly, in this embodiment, the battery compartment is defined by the interior of the cabinet. The rechargeable batteries are encased in a polymeric material which includes a heating element embedded in the casing. The heating elements of the batteries are connected to the controller in use. The casing for the batteries further includes an exhaust conduit to prevent the build-up of any hydrogen gas generated by the batteries in use.

The rechargeable batteries are electrically connected to an output from the photovoltaic panels 12 via the controller. The controller conditions the electrical energy received from the panels 12 and the conditioned electrical energy is stored by the rechargeable batteries for subsequent use in powering the electrical devices which are carried by the mast 10 and electrically connected to the batteries.

In use, the container 4 is transported to a desired location using a suitable vehicle. During transportation, the apparatus 2 is in a storage configuration in which the mast 10 has been fully retracted to its lowest height and each of the arrays 14 has been hinged such that it is lying parallel with and adjacent to the respective container panel to which it is coupled. Once the container 4 has been located in the desired location, the apparatus 2 is moved to an active configuration in which each of the arrays 14 of photovoltaic panels 12 is oriented for maximum solar strike and is secured in that orientation via the support arms 20, the track 22 and the restraining elements. In addition, the mast 10 is elevated to its maximum height via the winch apparatus 24 and latched in this position.

With the arrays 14 of photovoltaic panels 12 in the desired orientation, electrical energy is generated from the sunlight striking the panels 12. The electrical energy is conditioned by the controller to a suitable voltage and then stored in the batteries.

When the batteries are sufficiently charged with electrical energy, the PTZ video camera 26 and the wireless access point 28 may be operated as desired.

As the photovoltaic panels 12 generate more electrical energy than is consumed by the camera 26 and the wireless access point 28, the camera may be operated and its feed monitored for long periods of time with little or no need for a human presence on site.

When the temperature drops below a pre-determined threshold value, the controller energises the heating elements carried by the batteries to maintain the temperature of the batteries above a minimum temperature. As an alternative to providing heating elements within an enclosure around each battery, the cabinet within which the batteries are located may include one or more heating elements.

Similarly, if the temperature within the cabinet exceeds a pre-determined threshold value, a fan or other cooling apparatus located within the cabinet may be activated to vent the excess heat from the cabinet. It will be appreciated that the fan or other cooling apparatus may be powered by the rechargeable batteries.

1. A power generating apparatus for use in remote locations, the apparatus including a shipping container; an elongate device support element secured to the shipping container and configured to be upstanding in use; an electrical energy storage assembly located within the shipping container, the electrical energy storage assembly having an electrical input and an electrical output, and comprising one or more rechargeable batteries; an electrical energy generator carried externally by the shipping container, wherein the electrical energy generator is the sole source of electrical energy and is powered by solar energy and optionally wind energy, the electrical energy generator including one or more photovoltaic panels configured to convert solar energy into electrical energy, the electrical energy from the electrical energy generator being electrically connected to the input of the energy storage assembly; and a powered device carried by the device support element, the powered device being selected from a camera, a lighting apparatus, a wireless communications assembly, a radar apparatus, a gas detection apparatus and combinations thereof, wherein the powered device is electrically coupled to the output of the energy storage assembly.

2. A power generating apparatus according to claim 1, wherein the electrical energy generator includes two or more photovoltaic panels.

3. A power generating apparatus according to claim 2, wherein the electrical energy generator includes at least one photovoltaic panel which has a variable orientation.

4. A power generating apparatus according to claim 3, wherein all of the photovoltaic panels have a variable orientation.

5. A power generating apparatus according to claim 2, wherein the electrical energy generator includes at least one fixed photovoltaic panel.

6. A power generating apparatus according to claim 2, wherein at least one of the photovoltaic panels is located on a roof panel of the shipping container.

7. A power generating apparatus according to claim 2, wherein at least one of the photovoltaic panels is located on a side wall panel of the shipping container.

8. A power generating apparatus according to claim 1, wherein the or each photovoltaic panel is coated with a protective barrier layer.

9. A power generating apparatus according to claim 1, wherein the shipping container includes at least one vent located in a panel of the container.

10. A power generating apparatus according to claim 9, wherein the or each vent has an open configuration in which the interior of the container is in fluid communication with an external environment, and a closed configuration in which the interior of the container is isolated from the external environment.

11. A power generating apparatus according to claim 1, wherein the electrical energy storage assembly is located within a compartment defined within the interior of the shipping container.

12. A power generating apparatus according to claim 11, wherein the compartment is insulated.

13. A power generating apparatus according to claim 11, wherein the compartment includes one or more heating elements electrically connected to the electrical output from the energy storage assembly.

14. A power generating apparatus according to claim 1, wherein the or each rechargeable battery is enclosed within a polymeric barrier layer.

15. A power generating apparatus according to claim 1, wherein the elongate device support element is secured to a roof panel of the shipping container.

16. A power generating apparatus according to claim 1, wherein the elongate device support element is secured to the floor of the shipping container and the shipping container defines an opening in a roof panel through which the elongate device support element extends in use.

17. A power generating apparatus according to claim 1, wherein the elongate device support element comprise a base and a telescopic mast.

18. A power generating apparatus according to claim 1, wherein the apparatus further includes a GPS location device electrically connected to an output from the energy storage assembly.
